(19) United States
(12) Patent Application Publication
(10) Pub. No.: US 2026/0352099 A1
(43) Pub. Date: Nov. 5, 2026

(54) RECONFIGURABLE DICKSON-BASED SWITCHED-CAPACITOR CONVERTER

(71) Applicant: Allegro MicroSystems, LLC, Manchester, NH (US)

(72) Inventors: Alessandro Dago, Pozzo d’Adda (IT); Luca Morinelli, Milano (IT)

(73) Assignee: Allegro MicroSystems, LLC, Manchester, NH (US)

(21) Appl. No.: 19/194,716

(22) Filed: Apr. 30, 2025

(51) Int. Cl. H02M 3/07; H02M 1/00; H02M 3/158

(52) U.S. Cl. CPC H02M 3/07; H02M 1/0095; H02M 3/158

(57) ABSTRACT

A reconfigurable Dickson-based switched-capacitor converter reduces inrush currents that charges/discharges the flying capacitors and the output capacitor, during configuration transitions, allowing the use of reconfigurable Dickson-based switched-capacitor converter in scenarios where the input voltage changes dynamically. The reconfigurable Dickson-based switched-capacitor converter includes a pre-charge circuit and a low dropout circuit to reduce inrush currents during configuration transitions, undervoltage conditions, and overvoltage conditions.

### BACKGROUND

Switched-capacitor converters are a family of DC-DC switching converters that only use capacitors and switches (usually MOSFETs) to perform a fixed ratio voltage conversion. In particular, the output voltage of the switched-capacitor converter only depends on the input voltage and on the topology characteristics conversion ratio, which is a fixed value. Based on the arrangement of the capacitors and the switches, different topologies can be implemented.

Conventional topologies are the ladder, the series-parallel, the Dickson, the Fibonacci, and the doubler. Based on the number of switches and capacitors, every topology can be configured to perform different conversion ratio.

For example, FIG. 1 illustrates a 4:1 Dickson switched-capacitor converter commonly used for 48V-to-12V voltage bus conversion. As illustrated in FIG. 1, the Dickson switched-capacitor converter is constructed of serially connected switches Q₁, Q₂, Q₃, and Q₄. A first set of serially connected switches, Q₅ and Q₆, are connected to switch Q₄, and a second set of serially connected switches, Q₇ and Q₈, are connected to switch Q₄ and in parallel to the first set of serially connected switches, Q₅ and Q₆. An output capacitor Cour is connected to switch Q₄.

A first side of flying capacitor C₁ is connected between switches Q₁ and Q₂, and a second side of flying capacitor C₁ is connected between switches Q₅ and Q₆. A first side of flying capacitor C₂ is connected between switches Q₂ and Q₃, and a second side of flying capacitor C₂ is connected between switches Q₇ and Q₈. A first side of flying capacitor C₃ is connected between switches Q₃ and Q₄, and a second side of flying capacitor C₃ is connected between switches Q₅ and Q₆.

The switches are controlled by signals Φ_{A} and Φ_{B}, wherein the 4:1 Dickson switched-capacitor converter is operated by alternating Φ_{A} and Φ_{B} with a 50% duty-cycle.

For sufficiently large values of C₁, C₂, and C₃, the voltage on the flying capacitors C₁, C₂, and C₃ can be considered constant and equal during the two phases of operation as follows:

$$\{ \begin{matrix}{V}_{{C}_{1}} {\vert}_{{Φ}_{A}} = {V}_{IN} - {V}_{OUT} \\ {V}_{{C}_{2}} {\vert}_{{Φ}_{A}} = {V}_{OUT} + {V}_{{C}_{3}} \\ {V}_{{C}_{3}} {\vert}_{{Φ}_{A}} = {V}_{{C}_{2}} - {V}_{OUT}\end{matrix} \qquad \{ \begin{matrix}{V}_{{C}_{1}} {\vert}_{{Φ}_{B}} = {V}_{OUT} + {V}_{{C}_{2}} \\ {V}_{{C}_{2}} {\vert}_{{Φ}_{B}} = {V}_{{C}_{1}} - {V}_{OUT} \\ {V}_{{C}_{3}} {\vert}_{{Φ}_{B}} = {V}_{OUT}\end{matrix}$$

such that:

$$\{ \begin{matrix}{V}_{{C}_{1}} = 3 {V}_{OUT} \\ {V}_{{C}_{2}} = 2 {V}_{OUT} \\ {V}_{{C}_{3}} = {V}_{OUT}\end{matrix} \to {V}_{IN} = 4 {V}_{OUT}$$

The absence of inductors in the switched-capacitor converter's topology of FIG. 1 enables the switched-capacitor converter of FIG. 1 to be appealing in high power/voltage applications, as the cost of inductors increase with those parameters.

For example, in traditional buck converters, to sustain high output currents, low DC resistance inductors with high saturation current are required. Moreover, to reduce the current ripple caused by high input voltage applications, high value of inductance must be selected, further increasing the cost of the DC resistance inductor.

An advantage of the switched-capacitor converter of FIG. 1 with respect to buck converters is the higher achievable power density due to the higher intrinsic energy density of capacitors with respect to inductors.

A further advantage of the switched-capacitor converter of FIG. 1 with respect to buck converters is the use of power MOSFETs with a blocking voltage lower than the input voltage. Since the modular structure of the switched-capacitor converter of FIG. 1, only a fraction of the VIN must be blocked by the devices. As a reference, the voltage rating of the devices (MOSFETs and capacitors) used in the topology of FIG. 1 are shown in the table of FIG. 2.

Since the switched-capacitor converter of FIG. 1 output voltage is only dependent on the input voltage and the intrinsic conversion ratio of the adopted topology, large input voltage variation would result in large output voltage variations, making the switched-capacitor converter of FIG. 1 not ideal in applications where the input voltage is not regulated, such as automotive applications based on a 48V battery system.

FIG. 3 shows the output voltage variation with respect to the input voltage in a 48V battery system, where the input voltage varies between 12V and 72V. The output voltage (10) is shown for a 3:1 switched-capacitor converter topology and the output voltage (20) is shown for a 4:1 switched-capacitor converter topology. In both cases the output voltage excursion is wide and does not guarantee a reliable operation of the following conversion stages in a typical application.

A conventional solution to this problem is the online reconfiguration of the power stage to perform different conversion ratios with the same converter topology. The conversion ratio is changed with the input voltage to reduce the output voltage variation. As an example, in FIG. 4, the output voltage of a switched-capacitor converter reconfigurable for four different conversion ratios (4:1, 3:1, 2:1, and 1:1) is shown, with the conversion ratio being dynamically changed with the input voltage.

The conventional solution provides a limited output voltage range even in the presence of wide input voltage range. One implementation of the conventional solution based on a Dickson switched-capacitor converter structure is illustrated in FIG. 5.

As illustrated in FIG. 5, the Dickson switched-capacitor converter includes three flying capacitor circuits (100, 125, and 150). Each flying capacitor circuit can exclude its associated capacitor from the Dickson switched-capacitor converter based upon the operations of the associated switches.

The illustrated Dickson switched-capacitor converter includes a first flying capacitor circuit 100, which is constructed of switches Q₁, Q_{2A}, Q₅, and Q₆. In the first flying capacitor circuit 100, a first side of flying capacitor C₁ is connected between switches Q₁ and Q_{2A}, and a second side of flying capacitor C₁ is connected between switches Q₅ and Q₆.

The illustrated Dickson switched-capacitor converter further includes a second flying capacitor circuit 125, which is constructed of switches Q_{2B}, Q_{3A}, Q₇, and Q₈. In the second flying capacitor circuit 125, a first side of flying capacitor C₂ is connected between switches Q_{2B} and Q_{3A}, and a second side of flying capacitor C₂ is connected between switches Q₇ and Q₈.

The illustrated Dickson switched-capacitor converter also includes a third flying capacitor circuit 150, which is constructed of switches Q_{3B}, Q₄, Q₉, and Q₁₀. In the third flying capacitor circuit 150, a first side of flying capacitor C₃ is connected between switches Q_{3B} and Q₄, and a second side of flying capacitor C₃ is connected between switches Q₉ and Q₁₀.

To achieve reconfigurability (conversion ratio selectable from 1:1, 2:1, 3:1 and 4:1) of the Dickson switched-capacitor converter, switches Q₉ and Q₁₀ (MOSFETs) have been included in the topology of the Dickson switched-capacitor converter.

To facilitate a better understanding of the Dickson switched-capacitor converter, in FIG. 5, switches Q₂ and Q₃ (MOSFETs) have been split into Q_{2A}/Q_{2B} and Q_{3A}/Q_{3B} to highlight the separation of the three different flying capacitor circuits.

The three flying capacitor circuits can be independently excluded from converter operation by short circuiting (turning permanently ON) the “high side” MOSFETs (Q₁ and Q_{2A} for C₁, Q_{2B} and Q_{3A} for C₂, Q_{3B} and Q₄ for C₃). A 4:1 ratio is obtained by switching all the flying capacitors. A 3:1 ratio is obtained by switching two flying capacitors. A 2:1 ratio is obtained by switching a single flying capacitor. A 1:1 ratio is obtained without switching any flying capacitor (Q₁-Q₄ ON).

However, in actual implementation, switches (Q_{2A} & Q_{2B}) and (Q_{3A} & Q_{3B}) (MOSFETs) are implemented as single MOSFETs Q₂ and Q₃, as illustrated in FIG. 6. With respect to FIG. 6, a first flying capacitor circuit includes switch Q₁ and a high side of switch Q₂, wherein a first side of flying capacitor C₁ is connected between switch Q₁ and the high side of switch Q₂, and a second side flying capacitor C₁ is connected between switch Q₅ and the high side of switch Q₆. A second flying capacitor circuit includes a low side of switch Q₂ and a high side of switch Q₃, wherein a first side of flying capacitor C₂ is connected between a low side of switch Q₂ and the high side of switch Q₃, and a second side flying capacitor C₂ is connected between switch Q₇ and the high side of switch Q₈. A third flying capacitor circuit includes a low side of switch Q₃ and switch Q₄, wherein a first side of flying capacitor C₃ is connected between a low side of switch Q₃ and switch Q₄, and a second side flying capacitor C₂ is connected between switch Q₉ and the high side of switch Q₁₀. An output capacitor Cour is connected to switch Q₄.

However, this conventional solution is subject to the presence of high inrush currents flowing in the switches (MOSFETs) and capacitances when transitioning from one conversion ratio to another. According to the selected conversion ratio, the voltage on every flying and output capacitor are different fractions of the input voltage, as highlighted in FIG. 7.

As the conversion ratio transitions from one value to another, the voltages on capacitors must track the levels shown in FIG. 7, leading to high inrush currents to charge/discharge the capacitors.

Thus, it is desirable to provide a reconfigurable switched-capacitor converter that reduces or prevents high inrush currents to charge/discharge the capacitors.

### SUMMARY

According to an aspect of the disclosure, a switched-capacitor converter includes an input voltage node; an output voltage node; a first flying capacitor circuit operatively connected to the input voltage node, including a first input switch, a second input switch, a first capacitor, a first output switch, and a second output switch; a second flying capacitor circuit, operatively connected to the first flying capacitor, including the second input switch, a third input switch, a second capacitor, a third output switch, and a fourth output switch; a third flying capacitor circuit, operatively connected to the second flying capacitor, including the third input switch, a fourth input switch, a third capacitor, a fifth output switch, and a sixth output switch; and an output capacitor, operatively connected to the third flying capacitor circuit and the output voltage node; the first flying capacitor circuit, the second flying capacitor circuit, the third flying capacitor circuit, and the output capacitor being configured to control an output voltage at the output voltage based on a comparison of references voltages to an input voltage at the voltage input node.

In another embodiment, a first side of the first capacitor is electrically connected to the first and second input switches and a second side of the first capacitor is electrically connected to the first and second output switches; a first side of the second capacitor being electrically connected to the second and third input switches and a second side of the second capacitor being electrically connected to the third and fourth output switches; and a first side of the third capacitor being electrically connected to the third and fourth input switches and a second side of the third capacitor being electrically connected to the fifth and sixth output switches.

In further embodiments, an ON/OFF state of the first input switch, the third input switch, the first output switch, the fourth output switch, and the fifth output switch are controlled by a first control signal; and an ON/OFF state of the second input switch, the fourth input switch, the second output switch, the third output switch, and the sixth output switch are controlled by a second control signal.

In another embodiment, the switched-capacitor converter may also include a pre-charge circuit, wherein the pre-charge circuit is operatively connected to second capacitor and configured to pre-charge the second capacitor. The switched-capacitor converter may include a low dropout circuit, wherein the low dropout circuit is operatively connected to the second and third input switches and is configured to linearly control the second and third input switches in a constant current mode to limit current value to a reference current value.

In other embodiments, the switched-capacitor converter may include a controller operatively connected to a pre-charge circuit, the low dropout circuit, the first flying capacitor circuit, the second flying capacitor circuit, the third flying capacitor circuit, the output capacitor, the voltage output node, and the voltage input node; the controller being configured to receive the input voltage from the voltage input node and to compare the received input voltage with a plurality of input voltage thresholds to determine an operational conversion ratio for the switched-capacitor converter; the controller generating control signals to control the outputs of the flying capacitor circuits according to the determined operational conversion ratio for the switched-capacitor converter. The switched-capacitor converter may include a controller operatively connected to a pre-charge circuit, the low dropout circuit, the first flying capacitor circuit, the second flying capacitor circuit, the third flying capacitor circuit, the output capacitor, the voltage output node, and the voltage input node; the controller being configured to receive the output voltage from the voltage output node and to compare the received output voltage with a reference voltage to determine an overvoltage condition and an undervoltage condition, wherein the controller generates control signals to control the outputs of the flying capacitor circuits according to the determined overvoltage condition or the determined undervoltage condition.

In another embodiment, the controller may be configured to receive the output voltage from the voltage output node and to compare the received output voltage with a reference voltage to determine an overvoltage condition and an undervoltage condition, wherein the controller generates control signals to control the outputs of the flying capacitor circuits according to the determined overvoltage condition or the determined undervoltage condition.

According to another aspect of the disclosure, a method for controlling a switched-capacitor converter having a first flying capacitor circuit including a first input switch, a second input switch, a first capacitor, a first output switch, and a second output switch, a second flying capacitor circuit, operatively connected to the first flying capacitor, including the second input switch, a third input switch, a second capacitor, a third output switch, and a fourth output switch, a third flying capacitor circuit, operatively connected to the second flying capacitor, including the third input switch, a fourth input switch, a third capacitor, a fifth output switch, and a sixth output switch, an output capacitor, a voltage input node, and a voltage output node, operatively connected to the third flying capacitor circuit, includes (a) determining an operational ratio mode of the switched-capacitor converter by comparing a voltage at the voltage input node with a plurality of input voltage thresholds; (b) operating the switched-capacitor converter in a 4:1 ratio mode, when a first operational ratio mode of the switched-capacitor converter has been determined, by switching all flying capacitor circuits ON by applying alternatively a first control signal and a second control signal to the switches on the flying capacitor circuits; (c) operating the switched-capacitor converter in a 3:1 ratio mode, when a second operational ratio mode of the switched-capacitor converter has been determined, by switching the first and third flying capacitor circuits ON by applying alternatively the first control signal and the second control signal to the switches on the first and third flying capacitor circuits and by maintaining a constant voltage on the second capacitor using a pre-charge circuit; (d) operating the switched-capacitor converter in a 2:1 ratio mode, when a third operational ratio mode of the switched-capacitor converter has been determined, by switching the second flying capacitor circuit ON by applying alternatively the first control signal and the second control signal to the switches on the second flying capacitor circuit and by turning ON the first output switch and the sixth output switch; and (e) operating the switched-capacitor converter in a 1:1 ratio mode, when a fourth operational ratio mode of the switched-capacitor converter has been determined, by maintaining a constant voltage on the second capacitor using a pre-charge circuit and by turning ON the first output switch and the sixth output switch.

In other embodiments, the method may determine an undervoltage condition; turn ON, when the undervoltage condition has been determined, the first input switch, the fourth input switch, the first output switch, and the sixth output switch; maintain, when the undervoltage condition has been determined, a constant voltage on the second capacitor using a pre-charge circuit; and linearly charge, when the undervoltage condition has been determined, the voltage output node with a constant current by using a low dropout circuit to control the second and third input switches. The method may also turn OFF, when the undervoltage condition has been determined, the second output switch, the third output switch, the fourth output switch, and the sixth output switch.

In further embodiments, the method may determine an overvoltage condition; turn ON, when the overvoltage condition has been determined, the first input switch, the fourth input switch, the first output switch, and the sixth output switch; and maintain, when the overvoltage condition has been determined, a constant voltage on the second capacitor using a pre-charge circuit. The method may turn OFF, when the overvoltage condition has been determined, the second input switch, the third input switch, the second output switch, the third output switch, the fourth output switch, and the sixth output switch.

According to another aspect of the disclosure, a method for controlling a switched-capacitor converter during an overvoltage condition or an undervoltage condition, the switched-capacitor converter having a first flying capacitor circuit including a first input switch, a second input switch, a first capacitor, a first output switch, and a second output switch, a second flying capacitor circuit, operatively connected to the first flying capacitor, including the second input switch, a third input switch, a second capacitor, a third output switch, and a fourth output switch, a third flying capacitor circuit, operatively connected to the second flying capacitor, including the third input switch, a fourth input switch, a third capacitor, a fifth output switch, and a sixth output switch, an output capacitor, a voltage input node, and a voltage output node, operatively connected to the third flying capacitor circuit, includes (a) determining an undervoltage condition; (b) turning ON, when the undervoltage condition has been determined, the first input switch, the fourth input switch, the first output switch, and the sixth output switch; (c) maintaining, when the undervoltage condition has been determined, a constant voltage on the second capacitor using a pre-charge circuit; (d) linearly charging, when the undervoltage condition has been determined, the voltage output node with a constant current by using a low dropout circuit to control the second and third input switches; (e) determining an overvoltage condition; (f) turning ON, when the overvoltage condition has been determined, the first input switch, the fourth input switch, the first output switch, and the sixth output switch; and (g) maintaining, when the overvoltage condition has been determined, a constant voltage on the second capacitor using a pre-charge circuit.

In other embodiments, the method may turn OFF, when the undervoltage condition has been determined, the second input switch, the third input switch, the second output switch, the third output switch, the fourth output switch, and the sixth output switch. The method may turn OFF, when the overvoltage condition has been determined, the second input switch, the third input switch, the second output switch, the third output switch, the fourth output switch, and the sixth output switch.

### BRIEF DESCRIPTION OF THE DRAWINGS

The drawings are only for purposes of illustrating various embodiments and are not to be construed as limiting, wherein:

FIG. 1 is a schematic representation of a prior art 4:1 Dickson-based switched-capacitor converter;

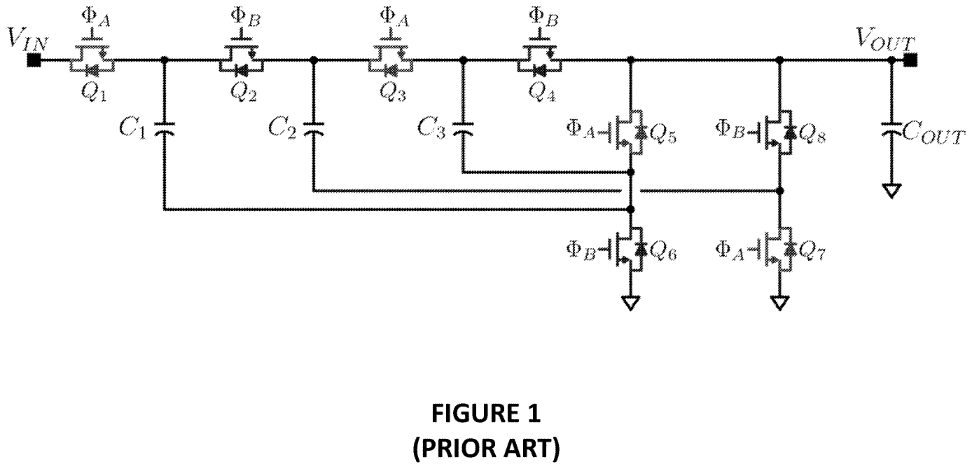

FIG. 2 is a table showing voltage ratings for the prior art 4:1 Dickson-based switched-capacitor converter of FIG. 1;

FIG. 3 graphically illustrates input-output ratio characteristics of a prior art fixed-ratio switched-capacitor converter;

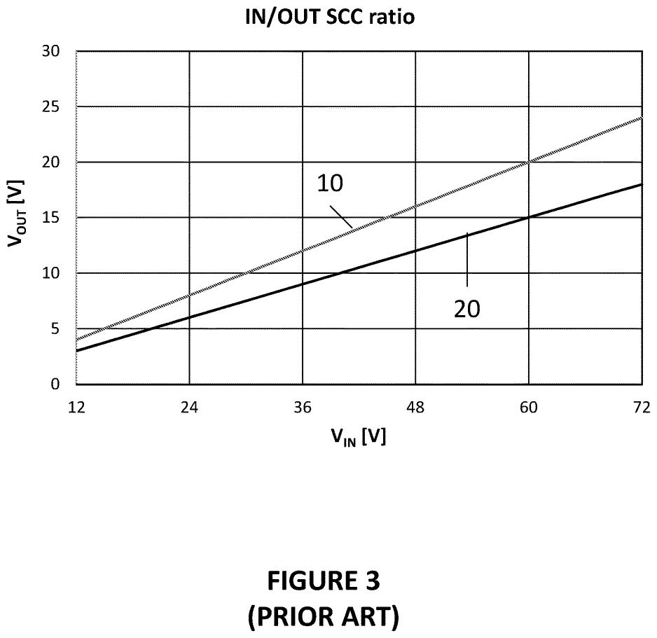

FIG. 4 graphically illustrates input-output ratio characteristics of a prior art reconfigurable switched-capacitor converter;

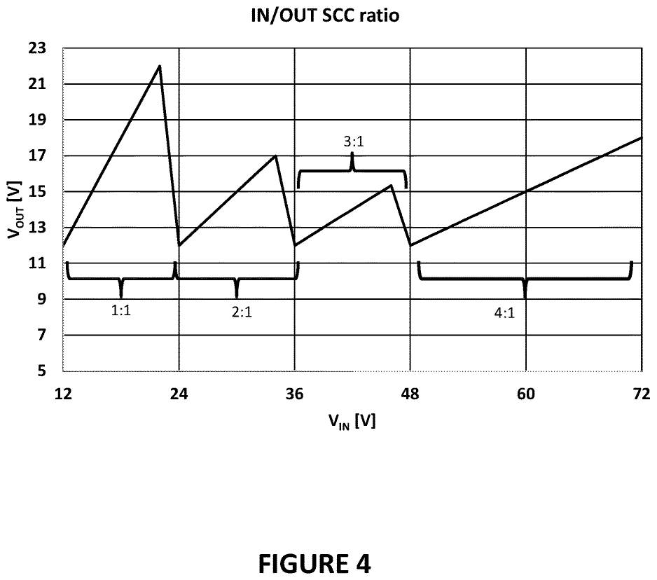

FIG. 5 is a schematic representation of a prior art reconfigurable Dickson-based switched-capacitor converter based on excludable flying capacitors with split switches;

FIG. 6 is a schematic representation of a prior art reconfigurable Dickson-based switched-capacitor converter of FIG. 5 based on excludable flying capacitors with unsplit switches;

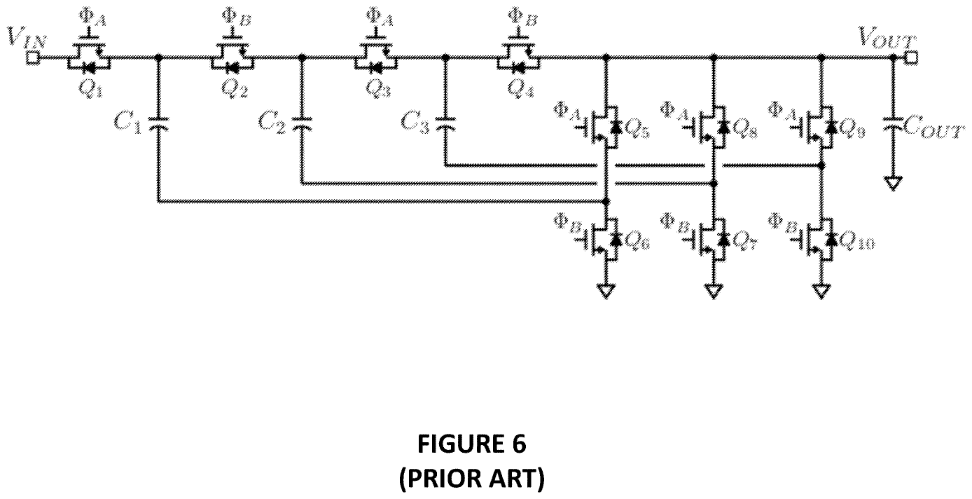

FIG. 7 graphically illustrates voltages on the flying and output capacitors of FIGS. 5 and 6;

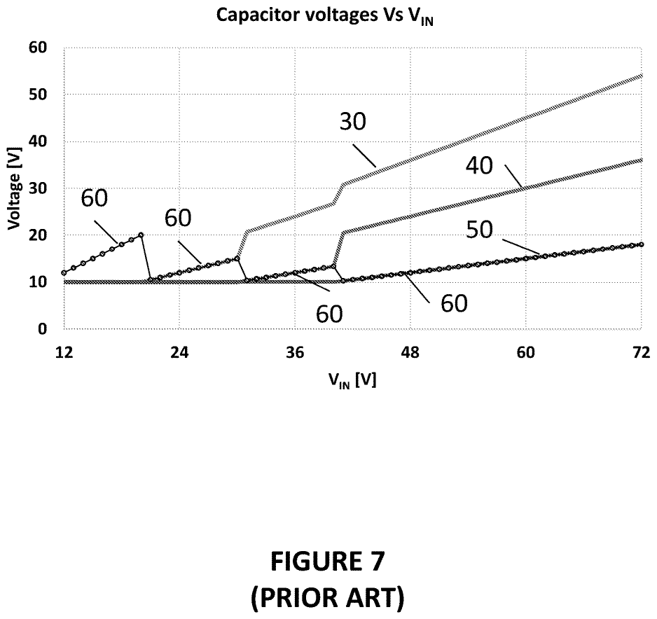

FIG. 8 is a schematic representation of a reconfigurable Dickson-based switched-capacitor converter based on excludable flying capacitors in accordance with example embodiments of the disclosure;

FIG. 9 is a table showing voltages and states for capacitors at various ratios;

FIG. 10 is a schematic representation of the reconfigurable Dickson-based switched-capacitor converter of FIG. 8 in a 4:1 ratio operation;

FIG. 11 is a schematic representation of the reconfigurable Dickson-based switched-capacitor converter of FIG. 8 in a 3:1 ratio operation;

FIG. 12 is a schematic representation of the reconfigurable Dickson-based switched-capacitor converter of FIG. 8 in a 2:1 ratio operation;

FIG. 13 is a schematic representation of the reconfigurable Dickson-based switched-capacitor converter of FIG. 8 in a 1:1 ratio operation;

FIG. 14 is a schematic representation of the reconfigurable Dickson-based switched-capacitor converter of FIG. 8 in a V_{OUT} increasing transition;

FIG. 15 is a schematic representation of the reconfigurable Dickson-based switched-capacitor converter of FIG. 8 in a V_{OUT} decreasing transition; and

FIG. 16 is a schematic representation of a control architecture for the reconfigurable Dickson-based switched-capacitor converter of FIG. 8.

### DETAILED DESCRIPTION OF THE DRAWINGS

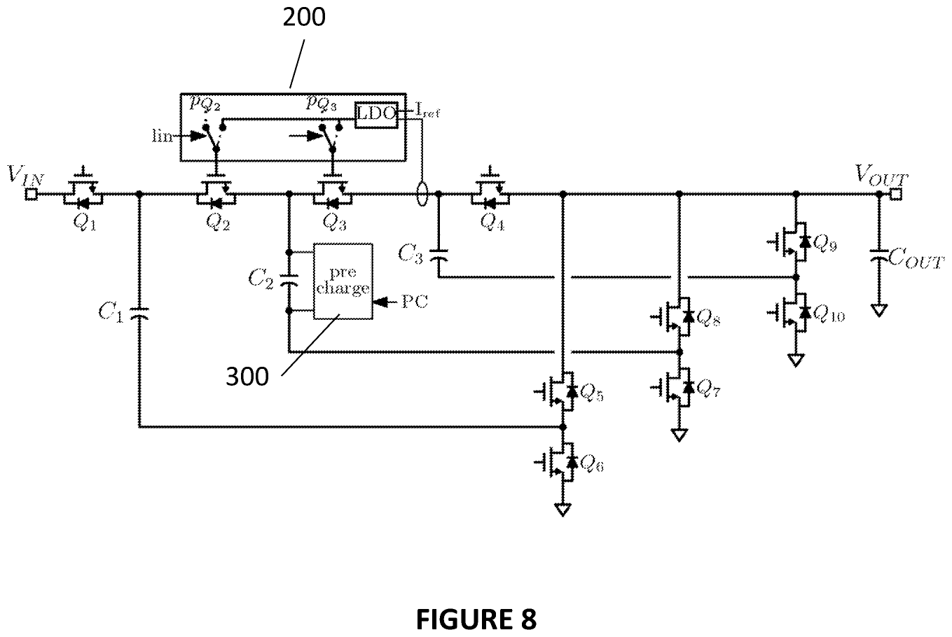

FIG. 8 shows a schematic representation of a reconfigurable Dickson-based switched-capacitor converter based on excludable flying capacitors. As illustrated in FIG. 8, the reconfigurable Dickson-based switched-capacitor converter includes a first flying capacitor circuit, a second flying capacitor circuit, and a third flying capacitor circuit. The first flying capacitor circuit includes switch Q₁ and a high side of switch Q₂, wherein a first side of flying capacitor C₁ is connected between switch Q₁ and the high side of switch Q₂, and a second side flying capacitor C₁ is connected between switch Q₅ and the high side of switch Q₆.

The second flying capacitor circuit includes a low side of switch Q₂ and a high side of switch Q₃, wherein a first side of flying capacitor C₂ is connected between a low side of switch Q₂ and the high side of switch Q₃, and a second side flying capacitor C₂ is connected between switch Q₇ and the high side of switch Q₈.

The third flying capacitor circuit includes a low side of switch Q₃ and switch Q₄, wherein a first side of flying capacitor C₃ is connected between a low side of switch Q₃ and switch Q₄, and a second side flying capacitor C₂ is connected between switch Q₉ and the high side of switch Q₁₀. An output capacitor Cour is connected to switch Q₄.

The reconfigurable Dickson-based switched-capacitor converter further includes a pre-charge circuit 300 and a low dropout circuit 200. The pre-charge circuit 300 is connected across flying capacitor C₂ to pre-charge flying capacitor C₂ to a desired value. The pre-charge circuit 300 may be a slow pre-charging circuit. The low dropout circuit 200 linearly controls switches Q₂ and Q₃ in a constant current mode to limit the current to the I_{REF} value.

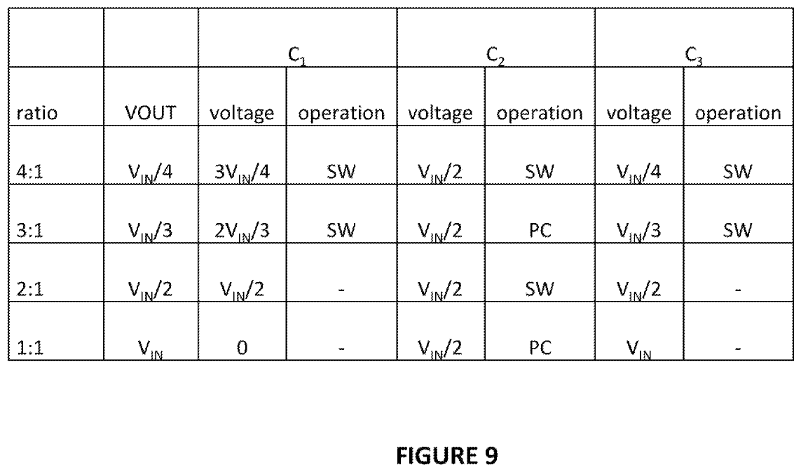

In the reconfigurable Dickson-based switched-capacitor converter of FIG. 8, inrush currents are minimized by referencing the voltages of the three flying capacitors in the four possible conversion ratio configurations to fixed values, only depending on VOUT and VIN, and not to the conversion ratio. This is realized in different ways for the three flying capacitors, according to the table shown in FIG. 9.

As illustrated in FIG. 9, the operating capacitors DC voltages and states are shown for the reconfigurable Dickson-based switched-capacitor converter of FIG. 8. In the table, SW means that the relative flying capacitor circuit is switching, and PC means that the C₂ pre-charge circuit 300 is active and keeping V_{C2}=V_{IN}/2. Moreover, the table of FIG. 9 shows that V_{C1}=V_{IN}−V_{OUT}, V_{C2}=V_{IN}/2 and V_{C3}=V_{OUT}.

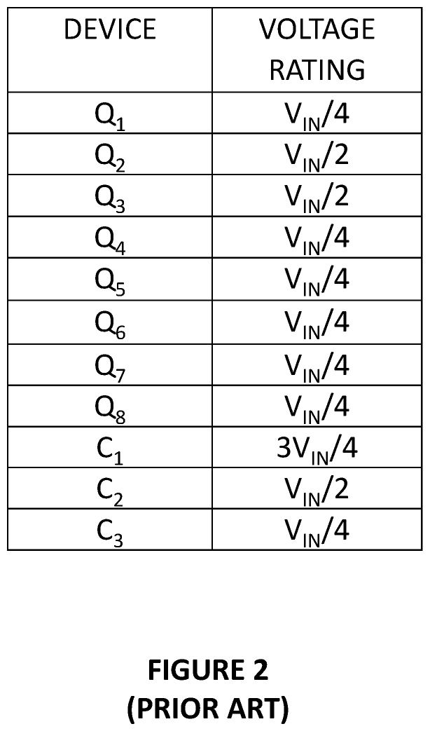

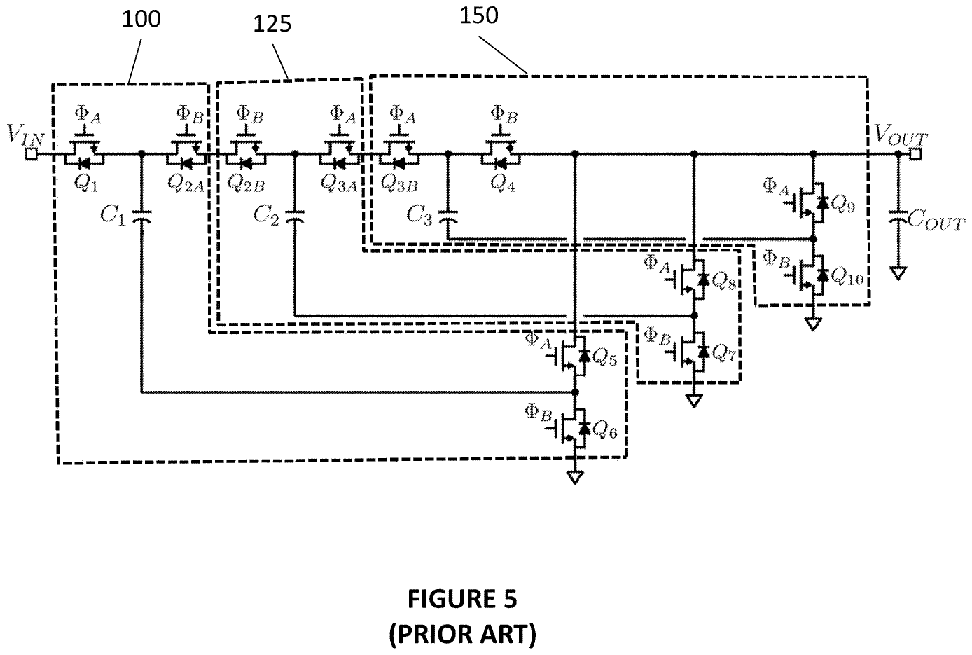

For a conversion ratio of 4:1, the reconfigurable Dickson-based switched-capacitor converter of FIG. 8 is controlled by switching all three flying capacitors between PA and PB as shown in FIG. 5. The capacitor voltages correspond to the values shown in the table in FIG. 2.

For a conversion ratio of 3:1, only flying capacitors C₁ and C₃ of the reconfigurable Dickson-based switched-capacitor converter of FIG. 8 are switched, leading to V_{OUT}=V_{IN}/3. The voltage on flying capacitor C₂ is kept constant and equal to V_{IN}/2 with the pre-charge circuit 300.

For a conversion ratio of 2:1, only flying capacitor C₂ of the reconfigurable Dickson-based switched-capacitor converter of FIG. 8 is switched, leading to V_{OUT}=V_{IN}/2. Flying capacitors C₁ and C₃ capacitors are kept at V_{IN}−V_{OUT}=V_{IN}/2 and V_{OUT}=V_{IN}/2, respectively, turning ON Q₅ and Q₁₀.

For a conversion ratio of 1:1, none of the flying capacitors are switched, leading to V_{OUT} being directly connected to V_{IN}. The voltage on C₂ is kept constant with the pre-charge circuit 300 and equal to V_{IN}/2. Flying capacitors C₁ and C₃ are kept at V_{IN}−V_{OUT}=0 and V_{OUT}=V_{IN}, respectively, by turning ON Q₅ and Q₁₀.

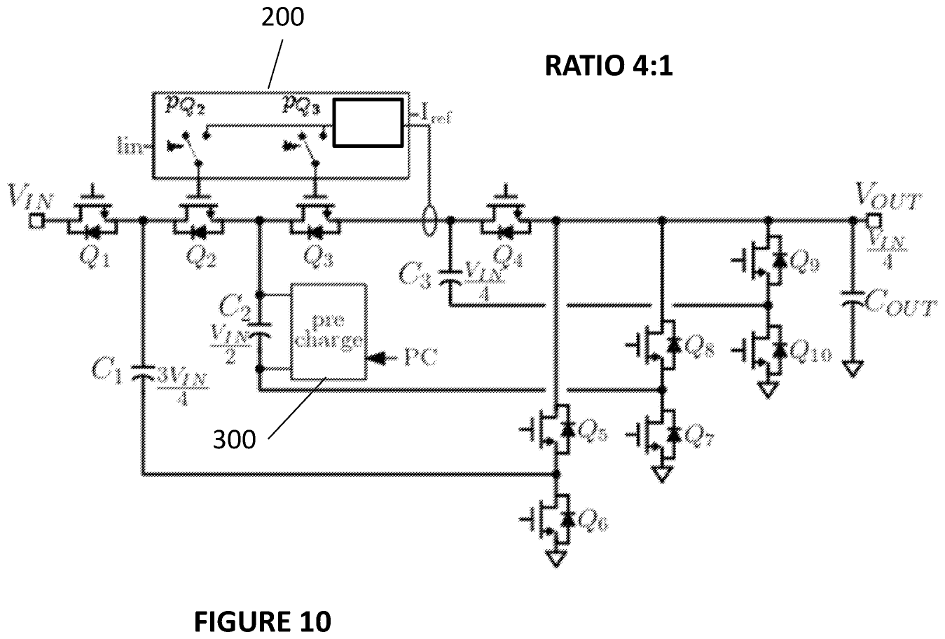

FIG. 10 illustrates the operational state of the reconfigurable Dickson-based switched-capacitor converter of FIG. 8 for a conversion ratio of 4:1. In this operational state, switches Q₁, Q₃, Q₅, Q₇, and Q₉ are ON and controlled by Φ_{A}. Moreover, switches Q₂, Q₄, Q₆, Q₈, and Q₁₀ are ON and controlled by Φ_{B}.

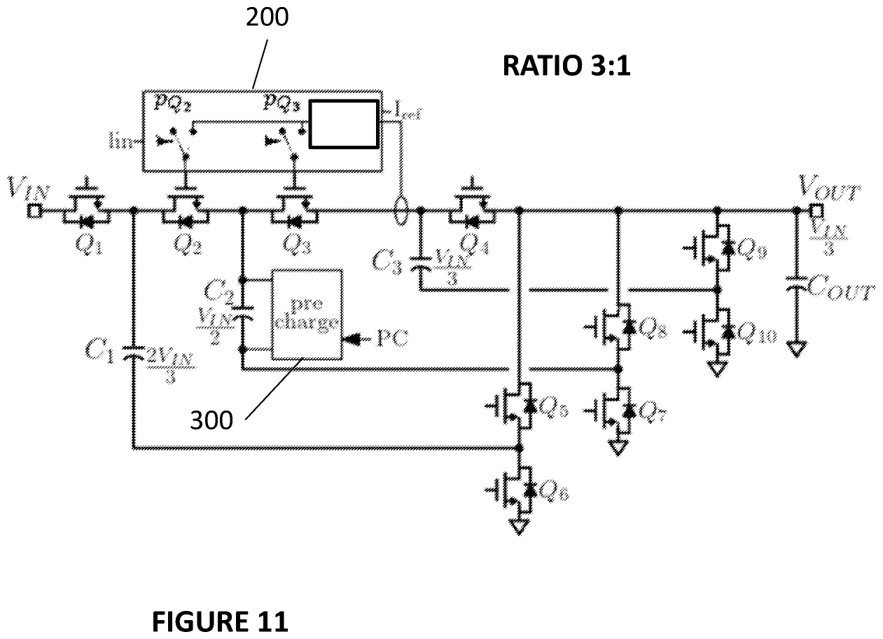

FIG. 11 illustrates the operational state of the reconfigurable Dickson-based switched-capacitor converter of FIG. 8 for a conversion ratio of 3:1. In this operational state, switches Q₁, Q₄, Q₅, and Q₁₀ are ON and controlled by Φ_{A}. Moreover, switches Q₂, Q₆, and Q₉ are ON and controlled by Φ_{B}. Switch Q₃ is ON. Switches Q₇ and Q₈ are OFF. The voltage on C₂ is kept constant and equal to V_{IN}/2 with the pre-charge circuit 300.

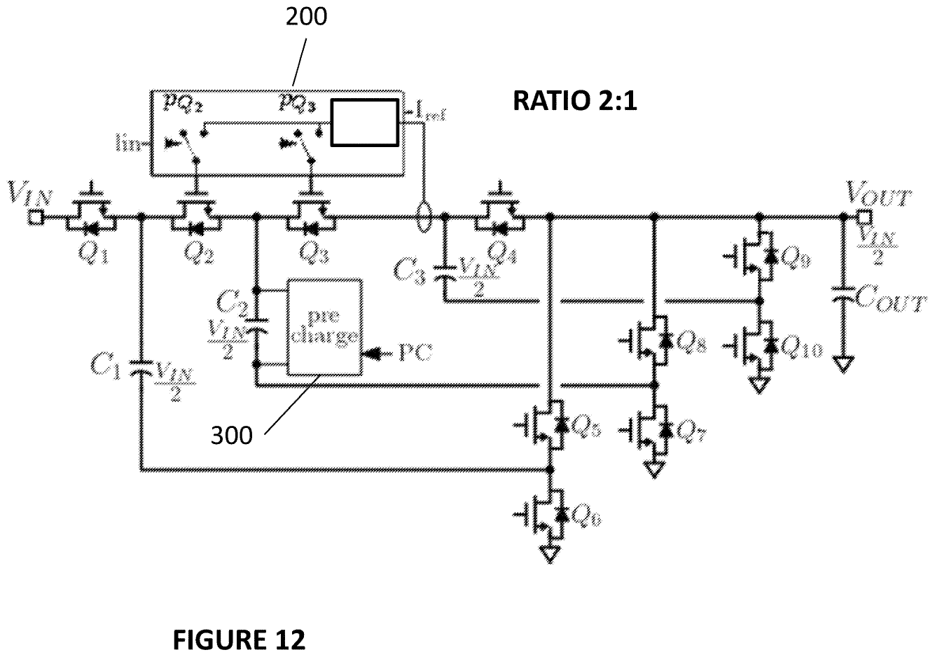

FIG. 12 illustrates the operational state of the reconfigurable Dickson-based switched-capacitor converter of FIG. 8 for a conversion ratio of 2:1. In this operational state, switches Q₁, Q₄, Q₅, and Q₁₀ are ON. Moreover, switches Q₂ and Q₈, are ON and controlled by Φ_{A}. Switches Q₃ and Q₇, are ON and controlled by Φ_{B}. Switches Q₆ and Q₉ are OFF.

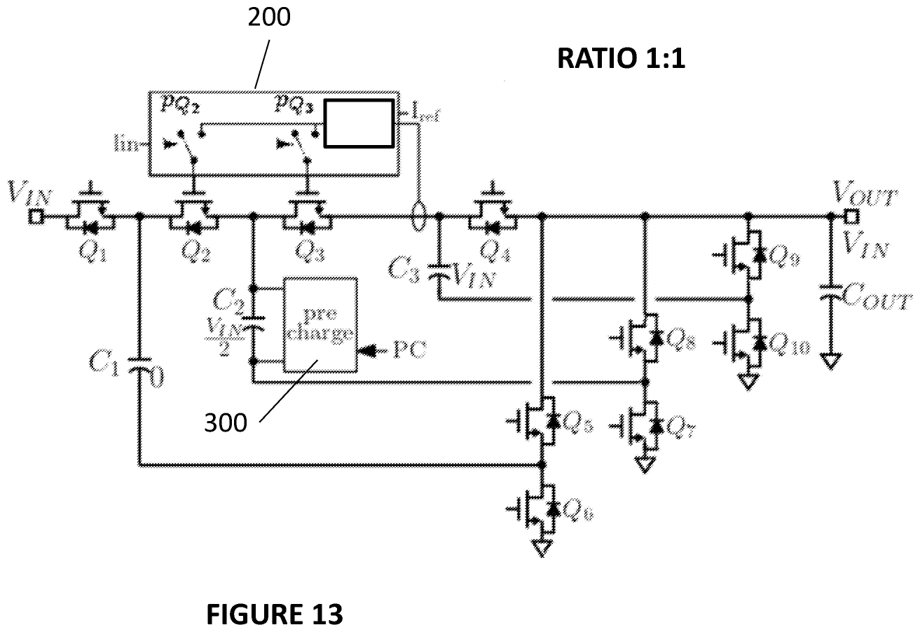

FIG. 13 illustrates the operational state of the reconfigurable Dickson-based switched-capacitor converter of FIG. 8 for a conversion ratio of 1:1. In this operational state, switches Q₁, Q₂, Q₃, Q₄, Q₅, and Q₁₀ are ON. Switches Q₆, Q₇, Q₈, and Q₉ are OFF. The voltage on C₂ is kept constant and equal to V_{IN}/2 with the pre-charge circuit 300.

With respect to the various operational states illustrated in FIGS. 10-13, the voltages on the flying capacitors track the V_{IN} and V_{OUT} voltages, avoiding inrush currents during ratio transitions. However, the output capacitor C_{OUT} is still subjected to abrupt voltage variations during ratio transitions, which leads to unwanted inrush currents in C_{OUT}, the flying capacitors and switches (MOSFETs).

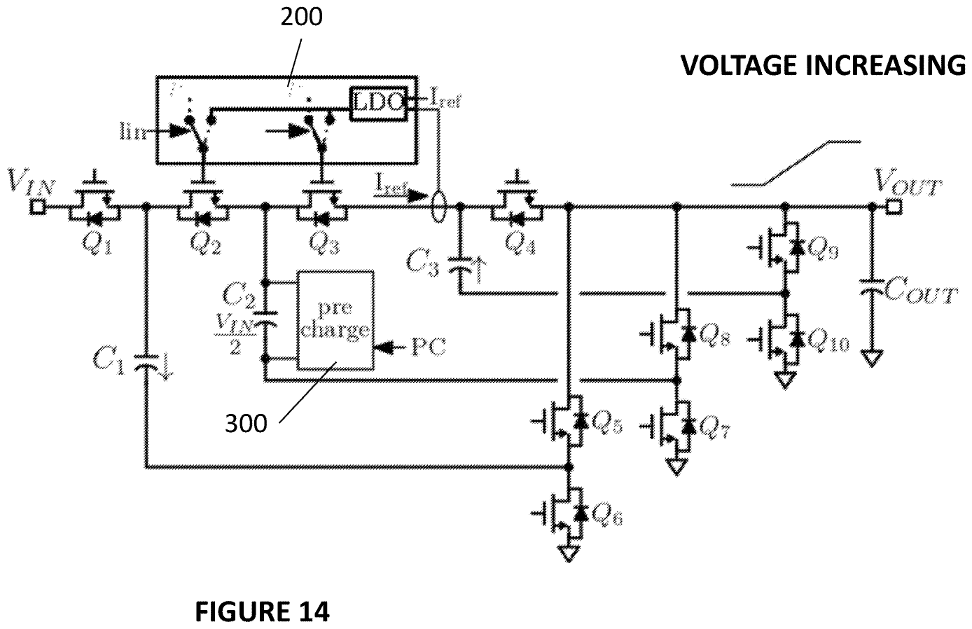

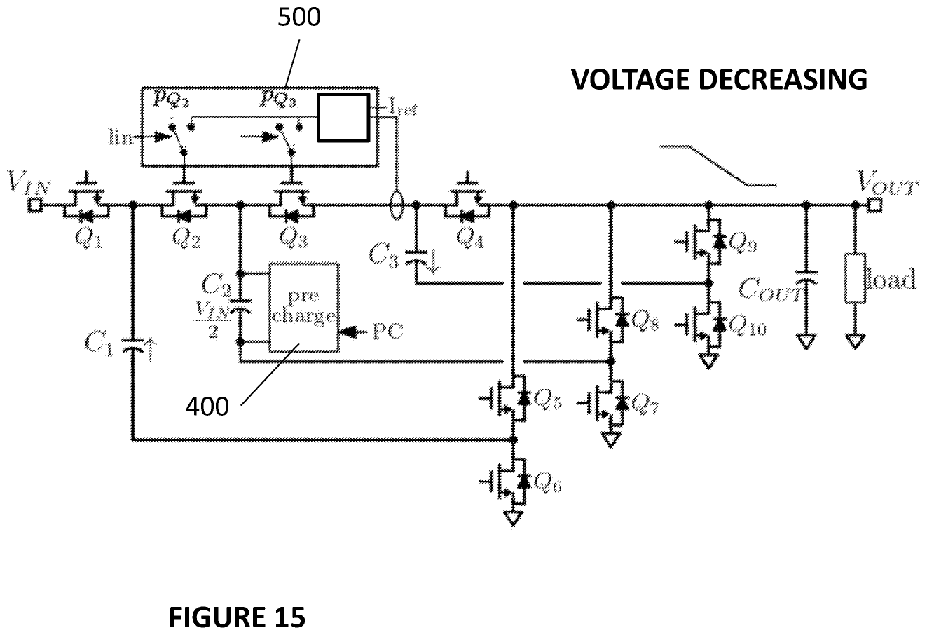

To limit the dv/dt on C_{OUT}, and consequently the inrush currents, two operational techniques depending on the type of transition (V_{OUT} increasing or decreasing), are implemented, as illustrated in FIGS. 14 and 15.

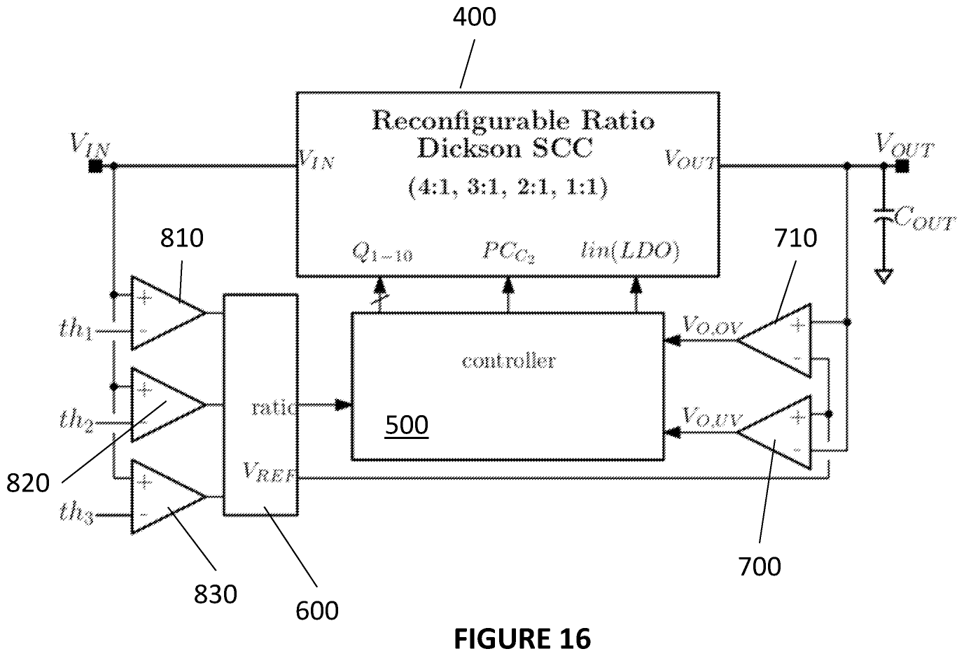

FIG. 14 illustrates the V_{OUT} increasing transition (4:1 to 3:1, 3:1 to 2:1, and 2:1 to 1:1) for the reconfigurable Dickson-based switched-capacitor converter of FIG. 8. The V_{OUT} increasing transition is detected by an undervoltage comparator (see FIG. 16) at an output node of the reconfigurable Dickson-based switched-capacitor converter of FIG. 8.

As illustrated in FIG. 14, during the V_{OUT} increasing transition, Q₁, Q₅, Q₄ and Q₁₀ are in ON state, to provide a smooth transition of the voltages on C₁ and C₃. Pre-charge circuitry 300 is turned ON to maintain V_{C2}=V_{IN}/2. The V_{OUT} node is linearly charged with the low dropout circuit 200 controlling switches Q₂ and Q₃ with constant current. Once V_{OUT} is high enough to disengage the undervoltage comparator (not shown), switching activity is resumed.

FIG. 15 illustrates the V_{OUT} decreasing transition (1:1 to 2:1, 2:1 to 3:1, and 3:1 to 4:1) for the reconfigurable Dickson-based switched-capacitor converter of FIG. 8. The V_{OUT} decreasing transition is detected by an overvoltage comparator (see FIG. 16) at an output node of the reconfigurable Dickson-based switched-capacitor converter of FIG. 8.

As illustrated in FIG. 15, during the V_{OUT} decreasing transition, Q₁, Q₅, Q₄ and Q₁₀ are in ON state, to provide smooth transition of the voltages on C₁ and C₃. Pre-charge circuitry 300 is turned ON to maintain V_{C2}−V_{IN}/2. The output node is linearly discharged by the load or by leakage current. Once V_{OUT} is low enough to disengage the overvoltage comparator, switching activity is resumed.

FIG. 16 illustrates a control architecture for the reconfigurable Dickson-based switched-capacitor converter of FIG. 8 to provide the operations described above. As illustrated in FIG. 16, a reconfigurable Dickson-based switched-capacitor converter 400 receives an input voltage V_{IN} and outputs an output voltage V_{OUT}, depending on the desired conversion ratio. The reconfigurable Dickson-based switched-capacitor converter 400 is connected to a controller 500 which provides the control signals for the switches Q₁-Q₁₀ of FIG. 8, the pre-charge circuit 300 of FIG. 8, and the low dropout circuit 200 of FIG. 8.

To determine the conversion ratio (the output voltage range), the input voltage V_{IN} is compared to three threshold values th₁, th₂, and th₃ by comparators 810, 820, and 830. VREF is the desired output voltage reference, corresponding to V_{IN}/4 for ratio 4:1, V_{IN}/3 for ratio 3:1, V_{IN}/2 for ratio 2:1, and V_{IN} for ratio 1:1.

To determine an overvoltage condition, comparator 710 compares V_{OUT} to VREF and sets a flag V_{O,OV} if an overvoltage condition is detected. To determine an undervoltage condition, comparator 720 compares V_{OUT} to VREF and sets a flag V_{O,UV} if an undervoltage condition is detected.

The reconfigurable Dickson-based switched-capacitor converter of FIG. 8 with the control architecture of FIG. 16, enables Dickson-based switched-capacitor converter of FIG. 8 to be utilized in wide input voltage/high power applications.

The inrush currents that charges/discharges the flying capacitors and the output capacitor, during configuration transitions, are reduced or eliminated, allowing the use of reconfigurable Dickson-based switched-capacitor converter in scenarios where the input voltage changes dynamically.

Moreover, the reconfigurable Dickson-based switched-capacitor converter of FIG. 8 with the control architecture of FIG. 16 can be utilized for 48V to 12V nominal voltage conversion in automotive applications, where the nominal input voltage is defined in a wide 12/72V range. The reconfigurable Dickson-based switched-capacitor converter can also provide an unregulated output voltage in the 10/18V range.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

What is claimed is:

1. A switched-capacitor converter comprising:
an input voltage node;
an output voltage node;
a first flying capacitor circuit operatively connected to said input voltage node, including a first input switch, a second input switch, a first capacitor, a first output switch, and a second output switch;
a second flying capacitor circuit, operatively connected to said first flying capacitor, including said second input switch, a third input switch, a second capacitor, a third output switch, and a fourth output switch;
a third flying capacitor circuit, operatively connected to said second flying capacitor, including said third input switch, a fourth input switch, a third capacitor, a fifth output switch, and a sixth output switch; and
an output capacitor, operatively connected to said third flying capacitor circuit and said output voltage node;
said first flying capacitor circuit, said second flying capacitor circuit, said third flying capacitor circuit, and said output capacitor being configured to control an output voltage at said output voltage based on a comparison of references voltages to an input voltage at said voltage input node.

2. The switched-capacitor converter as claimed in claim 1, wherein a first side of said first capacitor is electrically connected to said first and second input switches and a second side of said first capacitor is electrically connected to said first and second output switches;
a first side of said second capacitor being electrically connected to said second and third input switches and a second side of said second capacitor being electrically connected to said third and fourth output switches;
a first side of said third capacitor being electrically connected to said third and fourth input switches and a second side of said third capacitor being electrically connected to said fifth and sixth output switches.

3. The switched-capacitor converter as claimed in claim 1, wherein an ON/OFF state of said first input switch, said third input switch, said first output switch, said fourth output switch, and said fifth output switch are controlled by a first control signal;
an ON/OFF state of said second input switch, said fourth input switch, said second output switch, said third output switch, and said sixth output switch are controlled by a second control signal.

4. The switched-capacitor converter as claimed in claim 1, further comprising:
a pre-charge circuit;
said pre-charge circuit being operatively connected to second capacitor and configured to pre-charge said second capacitor.

5. The switched-capacitor converter as claimed in claim 1, further comprising:
a low dropout circuit;
said low dropout circuit being operatively connected to said second and third input switches;
said low dropout circuit being configured to linearly control said second and third input switches in a constant current mode to limit current value to a reference current value.

6. The switched-capacitor converter as claimed in claim 4, further comprising:
a low dropout circuit;
said low dropout circuit being operatively connected to said second and third input switches;
said low dropout circuit being configured to linearly control said second and third input switches in a constant current mode to limit current value to a reference current value.

7. The switched-capacitor converter as claimed in claim 4, further comprising:
a controller operatively connected to said pre-charge circuit, said low dropout circuit, said first flying capacitor circuit, said second flying capacitor circuit, said third flying capacitor circuit, said output capacitor, said voltage output node, and said voltage input node;
said controller being configured to receive the input voltage from said voltage input node and to compare the received input voltage with a plurality of input voltage thresholds to determine an operational conversion ratio for the switched-capacitor converter;
said controller generating control signals to control the outputs of said flying capacitor circuits according to the determined operational conversion ratio for the switched-capacitor converter.

8. The switched-capacitor converter as claimed in claim 4, further comprising:
a controller operatively connected to said pre-charge circuit, said low dropout circuit, said first flying capacitor circuit, said second flying capacitor circuit, said third flying capacitor circuit, said output capacitor, said voltage output node, and said voltage input node;
said controller being configured to receive the output voltage from said voltage output node and to compare the received output voltage with a reference voltage to determine an overvoltage condition and an undervoltage condition;
said controller generating control signals to control the outputs of said flying capacitor circuits according to the determined overvoltage condition or the determined undervoltage condition.

9. The switched-capacitor converter as claimed in claim 7, wherein said controller is configured to receive said output voltage from said voltage output node and to compare the received output voltage with a reference voltage to determine an overvoltage condition and an undervoltage condition;
said controller generating control signals to control the outputs of said flying capacitor circuits according to the determined overvoltage condition or the determined undervoltage condition.

10. A method for controlling a switched-capacitor converter having a first flying capacitor circuit including a first input switch, a second input switch, a first capacitor, a first output switch, and a second output switch, a second flying capacitor circuit, operatively connected to the first flying capacitor, including the second input switch, a third input switch, a second capacitor, a third output switch, and a fourth output switch, a third flying capacitor circuit, operatively connected to the second flying capacitor, including the third input switch, a fourth input switch, a third capacitor, a fifth output switch, and a sixth output switch, an output capacitor, a voltage input node, and a voltage output node, operatively connected to the third flying capacitor circuit, the method comprising:
(a) determining an operational ratio mode of the switched-capacitor converter by comparing a voltage at the voltage input node with a plurality of input voltage thresholds;
(b) operating the switched-capacitor converter in a 4:1 ratio mode, when a first operational ratio mode of the switched-capacitor converter has been determined, by switching all flying capacitor circuits ON by applying alternatively a first control signal and a second control signal to the switches on the flying capacitor circuits;
(c) operating the switched-capacitor converter in a 3:1 ratio mode, when a second operational ratio mode of the switched-capacitor converter has been determined, by switching the first and third flying capacitor circuits ON by applying alternatively the first control signal and the second control signal to the switches on the first and third flying capacitor circuits and by maintaining a constant voltage on the second capacitor using a pre-charge circuit;
(d) operating the switched-capacitor converter in a 2:1 ratio mode, when a third operational ratio mode of the switched-capacitor converter has been determined, by switching the second flying capacitor circuit ON by applying alternatively the first control signal and the second control signal to the switches on the second flying capacitor circuit and by turning ON the first output switch and the sixth output switch; and
(e) operating the switched-capacitor converter in a 1:1 ratio mode, when a fourth operational ratio mode of the switched-capacitor converter has been determined, by maintaining a constant voltage on the second capacitor using a pre-charge circuit and by turning ON the first output switch and the sixth output switch.

11. The method as claimed in claim 10, further comprising:
(f) determining an undervoltage condition;
(g) turning ON, when the undervoltage condition has been determined, the first input switch, the fourth input switch, the first output switch, and the sixth output switch;
(h) maintaining, when the undervoltage condition has been determined, a constant voltage on the second capacitor using a pre-charge circuit; and
(i) linearly charging, when the undervoltage condition has been determined, the voltage output node with a constant current by using a low dropout circuit to control the second and third input switches.

12. The method as claimed in claim 11, further comprising:
(j) turning OFF, when the undervoltage condition has been determined, the second output switch, the third output switch, the fourth output switch, and the sixth output switch.

13. The method as claimed in claim 10, further comprising:
(f) determining an overvoltage condition;
(g) turning ON, when the overvoltage condition has been determined, the first input switch, the fourth input switch, the first output switch, and the sixth output switch; and
(h) maintaining, when the overvoltage condition has been determined, a constant voltage on the second capacitor using a pre-charge circuit.

14. The method as claimed in claim 13 further comprising:
(i) turning OFF, when the overvoltage condition has been determined, the second input switch, the third input switch, the second output switch, the third output switch, the fourth output switch, and the sixth output switch.

15. The method as claimed in claim 11, further comprising:
(j) determining an overvoltage condition;
(k) turning ON, when the overvoltage condition has been determined, the first input switch, the fourth input switch, the first output switch, and the sixth output switch; and
(l) maintaining, when the overvoltage condition has been determined, a constant voltage on the second capacitor using a pre-charge circuit.

16. The method as claimed in claim 15, further comprising:
(m) turning OFF, when the overvoltage condition has been determined, the second input switch, the third input switch, the second output switch, the third output switch, the fourth output switch, and the sixth output switch.

17. A method for controlling a switched-capacitor converter during an overvoltage condition or an undervoltage condition, the switched-capacitor converter having a first flying capacitor circuit including a first input switch, a second input switch, a first capacitor, a first output switch, and a second output switch, a second flying capacitor circuit, operatively connected to the first flying capacitor, including the second input switch, a third input switch, a second capacitor, a third output switch, and a fourth output switch, a third flying capacitor circuit, operatively connected to the second flying capacitor, including the third input switch, a fourth input switch, a third capacitor, a fifth output switch, and a sixth output switch, an output capacitor, a voltage input node, and a voltage output node, operatively connected to the third flying capacitor circuit, the method comprising:
(a) determining an undervoltage condition;
(b) turning ON, when the undervoltage condition has been determined, the first input switch, the fourth input switch, the first output switch, and the sixth output switch;
(c) maintaining, when the undervoltage condition has been determined, a constant voltage on the second capacitor using a pre-charge circuit;
(d) linearly charging, when the undervoltage condition has been determined, the voltage output node with a constant current by using a low dropout circuit to control the second and third input switches;
(e) determining an overvoltage condition;
(f) turning ON, when the overvoltage condition has been determined, the first input switch, the fourth input switch, the first output switch, and the sixth output switch; and
(g) maintaining, when the overvoltage condition has been determined, a constant voltage on the second capacitor using a pre-charge circuit.

18. The method as claimed in claim 17, further comprising:
(h) turning OFF, when the undervoltage condition has been determined, the second input switch, the third input switch, the second output switch, the third output switch, the fourth output switch, and the sixth output switch.

19. The method as claimed in claim 17, further comprising:
(h) turning OFF, when the overvoltage condition has been determined, the second input switch, the third input switch, the second output switch, the third output switch, the fourth output switch, and the sixth output switch.

20. The method as claimed in claim 18, further comprising:
(i) turning OFF, when the overvoltage condition has been determined, the second input switch, the third input switch, the second output switch, the third output switch, the fourth output switch, and the sixth output switch.
